(19) United States
(12) Patent Application Publication
(10) Pub. No.: US 2021/0392937 A1
(43) Pub. Date: Dec. 23, 2021

(54) FOOD COMPOSITION FOR INHIBITING CARBOHYDRATE AND/OR LIPID ABSORPTION, FOOD OR DRINK CONTAINING THE SAME, AND METHOD FOR INHIBITING ABSORPTION

(71) Applicant: NISSIN FOODS HOLDINGS CO., LTD., Osaka-shi Osaka (JP)

(72) Inventors: Haruka YOSHINUMA, Osaka (JP); Nobuko INOIKE, Osaka (JP)

(21) Appl. No.: 17/279,345

(22) PCT Filed: Sep. 18, 2019
(86) PCT No.: PCT/JP2019/036526

§ 371 Date: Mar. 24, 2021

(30) Foreign Application Priority Data
Oct. 16, 2018 (JP) 2018-194716
Oct. 16, 2018 (JP) 2018-194717
Sep. 17, 2019 (JP) 2019-168457

(51) Int. Cl. A23L 33/22

(52) U.S. Cl. CPC A23L 33/22

(57) ABSTRACT

An object of the present invention is to provide a substance and a method capable of inhibiting carbohydrate and/or lipid absorption itself into the body instead of suppressing differentiation of adipocytes or accelerating metabolism of carbohydrate and/or lipid. The present invention provides a food composition for inhibiting carbohydrate and/or lipid absorption, containing psyllium husk as an active ingredient, and food or drink using the same. The present invention also provides a method for inhibiting dietary carbohydrate and/or lipid absorption, including ingesting a food composition for inhibiting carbohydrate and/or lipid absorption containing psyllium husk together with a meal. Thus, a part of carbohydrate and/or lipid ingested from a meal can be excreted out of the body without conversion into triglycerides. Besides, since the amounts of glucose and triglycerides in blood can be reduced, diabetes and arteriosclerosis can be prevented.

### TECHNICAL FIELD

The present invention relates to a composition for inhibiting carbohydrate and/or lipid absorption. More particularly, it relates to a composition for inhibiting carbohydrate and/or lipid absorption containing psyllium husk as an active ingredient.

### BACKGROUND ART

Recently, lifestyle diseases caused by lifestyle habits such as eating, physical exercise, smoking and drinking have become a problem in Japan. Examples of lifestyle diseases caused because of eating habits include diabetes, obesity, hyperlipidemia, hypertension, large intestine cancer, and periodontal disease. Among these, the lifestyle diseases such as diabetes, obesity, hyperlipidemia, and hypertension are particularly concerning because the number of patients of these diseases is large, and these diseases are closely related to onset of arteriosclerosis that can be a cause of cerebral infarction or myocardial infarction.

One type of obesity is visceral fat obesity (visceral fat accumulation) having fat accumulated in the abdomen. It has been found that the visceral fat accumulation easily causes diabetes, hyperlipidemia, hypertension, and the like. In addition, it has been also found that the risk of progression of arteriosclerosis increases when a patient suffers from two or more of these disease and as the number of the diseases is larger. Therefore, a state where visceral fat obesity is associated with two or more of hyperglycemia, hypertension and dyslipidemia is defined as metabolic syndrome, and attempts have been made to prevent or improve the lifestyle diseases by detecting metabolic syndrome at an early stage to provide appropriate guidance.

In obesity, adipocytes play a significant role. A part of carbohydrate and lipid that has not been able to be consumed out of those ingested from a meal is accumulated in adipocytes as triglycerides. As the triglycerides are accumulated in a larger amount, the adipocytes become hypertrophic. The adipocytes thus hypertrophied result in obesity.

For prevention and/or elimination of obesity, it is recommended to acquire exercise habits. For example, a bedridden person, however, cannot take exercise. Besides, it is difficult for a person who cannot stress moving organs (such as bones and joints) or circulatory organs, or a person who is busy every day to continue sustained exercise. Therefore, there arises a problem that sustained exercise cannot be done even if the person desires to do.

In addition to exercise, a method of dietary restriction has been proposed for preventing the lifestyle diseases. Dietary restriction gives, however, large mental burden to a person to be restricted in dietary, which easily builds up stress. As a result, some persons cannot continue dietary restriction.

Therefore, as a method for preventing and/or eliminating obesity except for dietary restriction, a method for suppressing differentiation of adipocytes has been proposed (Patent Literature 1).

### CITATION LIST

### Patent Literature

Patent Literature 1: Japanese Patent Laid-Open No. 2005-247695

### SUMMARY OF INVENTION

### Technical Problem

Although the substance described in the literature aims to suppress the differentiation of adipocytes, it neither suppresses conversion of unconsumed carbohydrate or lipid into triglycerides, nor inhibits accumulation of triglycerides in adipocytes. In other words, the substance does not inhibit carbohydrate or lipid absorption into the body. Besides, although not peculiar to the substance, the effect may be difficult to obtain in some persons due to the influence of their constitution, and the like.

The present inventors have not examined a substance suppressing differentiation of adipocytes or accelerating metabolism of carbohydrate and/or lipid, but a substance capable of inhibiting carbohydrate and/or lipid absorption itself into the body. As a result, it has been newly found that an effect of promoting excretion of carbohydrate and/or lipid into feces is increased by ingesting psyllium husk with a meal, and thus, the present invention has been accomplished.

### Solution to Problem

In order to solve the above-described problem, the present invention provides a food composition for inhibiting carbohydrate and/or lipid absorption containing psyllium husk as an active ingredient, and food or drink using the same. Besides, in order to solve the problem, the present invention provides a method for inhibiting dietary lipid absorption including ingesting a food composition for inhibiting carbohydrate and/or lipid absorption containing psyllium husk together with a meal.

According to this configuration, when the food composition containing psyllium husk as an active ingredient is ingested, an effect of excretion of carbohydrate and/or lipid into feces is accelerated. As a result, a part of carbohydrate and/or lipid ingested from a meal can be excreted out of the body without conversion into triglycerides.

### Advantageous Effects of Invention

According to the present invention, carbohydrate and/or lipid absorption into the body can be inhibited. Thus, carbohydrate and/or lipid to be converted into triglycerides is reduced, and hence triglycerides to be accumulated in adipocytes can be also reduced.

As a result, obesity can be prevented or eliminated. Besides, even a bedridden person or a person restricted in exercise can inhibit carbohydrate and/or lipid absorption merely by ingestion with a meal, and hence can prevent and/or eliminate obesity. Furthermore, since the amounts of glucose and triglycerides in blood can be thus reduced, diabetes and arteriosclerosis can be prevented.

### BRIEF DESCRIPTION OF DRAWINGS

FIG. 1 is a graph illustrating comparison in the amount of carbohydrate excreted into feces between a case of ingesting placebo food and a case of ingesting psyllium husk.

FIG. 2 is a graph illustrating comparison in the amount of lipid excreted into feces between a case of ingesting placebo food and a case of ingesting psyllium husk.

### DESCRIPTION OF EMBODIMENT

Now, a preferable embodiment of the present invention will be described.

<Psyllium Husk>

Psyllium husk is a dietary fiber material containing, as a principal component, polysaccharides having a highly branched structure. An example of the psyllium husk used in the present invention includes husk obtained from a seed of Plantago ovata, that is, a plant belonging to the Plantain family, or a ground product thereof. Here, examples of psyllium husk or a ground product thereof include those commercially available as psyllium, psyllium husk, a psyllium husk powder, psyllium seed gum, and isagol (hereinafter referred to as the “psyllium husk powder”). In the present invention, the psyllium husk powder may have any particle size or grade, and preferably contains little impurities and has a high purity.

A food composition of the present invention is not especially limited in the shape. The psyllium husk is highly safe, and hence can be easily continuously ingested for a long period of time. An ingesting method can be in the form of, for example, a tablet, a capsule, a granule, a powder, a syrup, a dry syrup, a liquid, a suspension, a jelly, or a powdered drink.

The food or drink of the present invention is not especially limited, and examples thereof include drinks, spreads, dressings, breads, cooked rice, noodles, sauces, and sweets.

The food or drink of the present invention can further contain various nutrients, various vitamins, minerals, dietary fibers, and various additives.

### Examples

The present invention will now be specifically described with reference to Examples. In this Example, an ingestion test was performed on 21 healthy adult males to examine effects of the present invention.

<Preparation of Sample>

First, a prescribed amount of psyllium was encapsulated in a hard gelatin capsule. Next, the number of capsules thus prepared corresponding to 10 g of psyllium husk was calculated. Here, the capsules corresponding to 10 g of psyllium husk were designated as Sample 1. Besides, the calculated number was designated as a base unit of the number of capsules to be ingested at one time in this Example.

Next, capsules adjusted to contain 4 g of psyllium husk per base unit were prepared by using dextrin. The resultant capsules were designated as Sample 2. Besides, capsule that dextrin alone was encapsulated in a hard gelatin capsule instead of psyllium husk was prepared, and the resultant was designated as Sample 3 (placebo food).

<Preparation of Pigment Capsule>

Brilliant blue FCF was encapsulated in a hard gelatin capsule to be used as a dye capsule. A content of brilliant blue FCF in one capsule was 30 mg.

<Test 1>

In this Example, a randomized double-blind crossover trial based on a single ingestion of each sample was performed. First, the 21 subjects were randomly divided into three groups. Each subject ingested a provided meal three times as breakfast, lunch and dinner on the day before and on the day when a sample and a dye capsule were ingested. Each subject ingested the sample and the dye capsule at breakfast on the day when the sample was ingested. Besides, a washout period between the respective samples was 7 days.

In the morning on the day after the sample was ingested, each subject collected the whole colored feces. The collected feces were placed in a cooler box with an ice pack to be sent to external clinical trial facilities.

<Measurement and Analysis of Carbohydrate Content>

The amount of carbohydrate, corresponding to total carbohydrate excluding dietary fiber, contained in the feces was analyzed by a conventional method in the clinical trial facilities. Next, the obtained analysis results were statistically analyzed to compare the results obtained in ingesting the psyllium husk with the results obtained in ingesting the placebo food. The statistical analysis was performed by the two-sided test, and a significance level was set to 5%. SPSS for Windows (Ver. 23.0, manufactured by IBM Japan, Ltd.) was used as analysis software, and linear mixed model, ANOVA, was selected as the statistical analysis method.

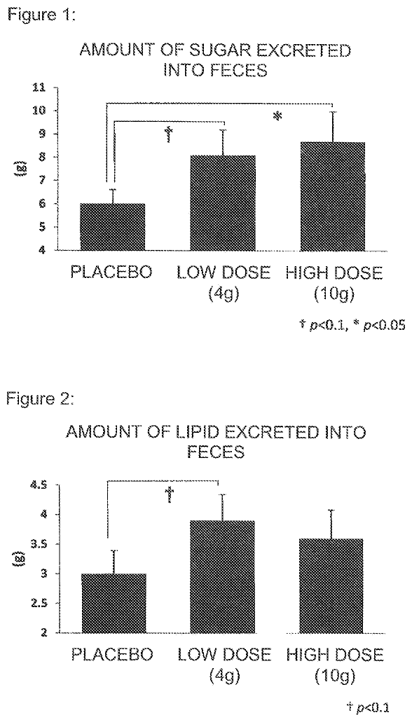

Results of the statistical analysis are illustrated in FIG. 1.

As is obvious from FIG. 1, the amount of sugar excreted into feces was increased by ingesting the psyllium husk. Specifically, as compared with a Sample 3 group (placebo food), the amount of excreted sugar was increased by 2.1 g (p<0.1) in a Sample 2 group (4 g of the psyllium husk), and was significantly increased by 2.7 g (p<0.05) in a Sample 1 group (10 g of the psyllium husk).

The percentage of excretion to sugar ingested from a provided meal (breakfast on the day when the sample was ingested) was, as compared with that of the Sample 3 group, increased by 2.3% in the Sample 2 group, and by 3.8% in the Sample 1 group.

<Measurement and Analysis of Lipid Content>

The amount of lipid contained in the feces was analyzed by a conventional method in the clinical trial facilities. Next, the obtained analysis results were statistically analyzed to compare the results obtained in ingesting the psyllium husk with the results obtained in ingesting the placebo food. The statistical analysis was performed by employing the same analysis method as that for carbohydrate.

Results of the statistical analysis are illustrated in FIG. 2.

As is obvious from FIG. 2, the amount of lipid excreted into feces was increased by ingesting the psyllium husk. Specifically, as compared with a Sample 3 group (placebo food), the amount of excreted lipid was increased by 0.9 g in a Sample 2 group (4 g of the psyllium husk), and was increased by 0.6 g in a Sample 1 group (10 g of the psyllium husk). In particular, in the Sample 2 group, increase trend was found at p<0.1.

The percentage of excretion to lipid ingested from a provided meal (breakfast on the day when the sample was ingested) was, as compared with that of the Sample 3 group, increased by 3.8% in the Sample 2 group, and by 2.6% in the Sample 1 group.

Here, the reason why the amount of excreted lipid was smaller in the Sample 1 group than in the Sample 2 group is presumed to be due to individual differences among the subjects on the average value, or that the amount of excreted lipid reaching peak when a dose of psyllium exceeds a provided amount.

The reason why the amount of sugar and/or lipid excreted into feces is increased by ingesting psyllium husk is assumed as follows: The ingested psyllium husk is swollen and forms gel by moisture ingested together with the psyllium husk and moisture in the body. The psyllium husk gel holds moisture therein. The psyllium husk is viscous, and the sugar and/or lipid are blocked from contacting with a digestive enzyme or a digestive organ by psyllium gel. As a result, it is assumed that the sugar and/or lipid are not absorbed through the digestive organ, but is excreted out of the body with feces.

<Test 2>

Next, with respect to suppression of increase of postprandial blood glucose level by ingestion of psyllium, a randomized double-blind crossover trial based on a single ingestion of a psyllium powder (3.72 g) or a placebo powder was performed. First, 49 subjects having a fasting blood glucose level of 100 mg/dL or more and 125 mg/dL or less were randomly divided into two groups. Each subject finished dinner before 21:00 on the day before each test day, and was fasted (but allowed to drink water alone) thereafter. Blood was collected next morning on an empty stomach, and the subject was made to ingest the psyllium powder or the placebo powder. Fifteen minutes after ingesting the psyllium powder or the placebo powder, the subject was made to ingest a provided meal (3 salted rice balls: 300 g of cooked rice), and blood was collected 30, 60, 90, and 120 minutes after starting the ingestion of the provided meal. Besides, the subject was fasted until blood was collected 120 minutes after the ingestion, and was made to sit and rest. It is noted that a washout period between the respective samples was 7 days.

<Blood Test and Analysis>

The postprandial blood glucose level was analyzed by a conventional method in clinical trial facilities. A primary evaluation item was an area under a blood concentration curve (AUC) based on change over time of the postprandial blood glucose level. In this test, a base line was drawn to calculate iAUC up to 120 minutes after the ingestion by using a trapezoidal method. Besides, a test result was indicated by mean±standard error (SE). Here, the term “iAUC” means an incremental amount of glucose contained in blood after the ingestion. Results are shown in Table 1.

TABLE 1

| | | | Standard |
|---|---|---|---|
| Parameter | | Value | Deviation |
| Glucose iAUC_{0-120 min} | Psyllium husk | 5142 ± 377 | P < 0.019* |
| (mg · min/dL) | Placebo | 5795 ± 450 | |

iAUC: incremental area under the curve.
Mean value was significantly different from placebo:
*p < 0.05, n = 49

As is obvious from Table 1, there was a significant difference between iAUC obtained in ingesting the psyllium powder and iAUC obtained in ingesting the placebo food. Specifically, it is understood that the blood glucose level is reduced by as much as about 12% in ingesting the provided meal than in ingesting the placebo food.

<Test 3>

Subsequently, with respect to suppression of increase of postprandial triglyceride level by ingestion of psyllium, a randomized double-blind crossover trial based on a single ingestion of a psyllium powder (3.72 g) or a placebo powder was performed. First, 76 subjects having a fasting blood triglyceride level less than 150 mg/dL were randomly divided into two groups. Each subject finished dinner before 21:00 on the day before each test day, and was fasted (but allowed to drink water alone) thereafter. Blood was collected next morning on an empty stomach, and the subject was made to ingest the psyllium powder or the placebo powder. Fifteen minutes after ingesting the psyllium powder or the placebo powder, the subject was made to ingest a high fat load diet, and blood was collected 2, 3, 4 and 6 hours after starting the ingestion of the high fat load diet. Besides, the subject was fasted until blood was collected 6 hours after the ingestion, and was made to sit and rest. It is noted that a washout period between the respective samples was 14 days.

<Load Diet>

The load diet was 180 g of hamburg steak, 2 butter rolls, and 30 g of shoestring potatoes (total: 731 kcal, 24.4 g of protein, 43.2 g of fat, and 61.3 g of carbohydrate).

<Blood Test and Analysis>

The postprandial blood triglyceride level was analyzed by a conventional method in clinical trial facilities. A primary evaluation item was an area under a blood concentration curve (AUC) based on change over time of the postprandial blood triglyceride level. In this test, a base line was drawn to calculate iAUC up to 6 hours after the ingestion by using a trapezoidal method. Besides, a test result was indicated by mean±standard error (SE). Here, the term “iAUC” means an incremental amount of triglycerides contained in blood after the ingestion. Results are shown in Table 2.

TABLE 2

| | | | Standard |
|---|---|---|---|
| Parameter | | Value | Deviation |
| TG iAUC_{0-6 h} | Psyllium husk | 631.1 ± 326.3 | P < 0.023* |
| (mg · h/dL) | Placebo | 696.1 ± 307.4 | |

iAUC: incremental area under the curve.
Mean value was significantly different from placebo:
*p < 0.05, n = 76

As is obvious from Table 2, there was a significant difference between iAUC obtained in ingesting the psyllium powder and iAUC obtained in ingesting the placebo food. Specifically, it is understood that the blood triglyceride level is reduced by as much as about 10% in ingesting the provided meal than in ingesting the placebo food.

Based on these results, the carbohydrate and/or lipid absorption into the body can be inhibited by ingesting psyllium husk. Thus, glucose and/or lipid to be converted into triglycerides is reduced, and hence triglycerides to be accumulated in adipocytes can be also reduced. As a result, obesity can be prevented or eliminated.

1. A food composition for inhibiting carbohydrate and/or lipid absorption, comprising psyllium husk as an active ingredient.

2. Food or drink, comprising the food composition for inhibiting carbohydrate and/or lipid absorption according to claim 1.

3. A method for inhibiting dietary carbohydrate and/or lipid absorption, comprising:
ingesting a food composition for inhibiting carbohydrate and/or lipid absorption containing psyllium husk together with a meal.
